(19) United States
(12) Patent Application Publication
(10) Pub. No.: US 2013/0198191 A1
(43) Pub. Date: Aug. 1, 2013

(54) METHOD FOR DETECTING COMMUNITIES IN MASSIVE SOCIAL NETWORKS BY MEANS OF AN AGGLOMERATIVE APPROACH

(71) Applicants: Rubén Lara Hernández, Madrid (ES); Rafael Pellón Gómez-Calcerrada, Madrid (ES); Arturo Canales González, Madrid (ES); David Millán Ruiz, Madrid (ES); Rocío Martínez López, Madrid (ES)

(72) Inventors: Rubén Lara Hernández, Madrid (ES); Rafael Pellón Gómez-Calcerrada, Madrid (ES); Arturo Canales González, Madrid (ES); David Millán Ruiz, Madrid (ES); Rocío Martínez López, Madrid (ES)

(21) Appl. No.: 13/809,107

(22) PCT Filed: Jul. 8, 2010
(86) PCT No.: PCT/ES2010/070471

§ 371 Date: Apr. 10, 2013

(51) Int. Cl. G06F 17/30

(52) U.S. Cl. CPC G06F 17/30598
USPC 707/737

(57) ABSTRACT

Disclosed is a method for detecting communities in massive social networks by means of an agglomerative approach in which core communities are built and gradually clustered in an iterative manner into higher level communities until the algorithm converges (a stop condition is met), whereby it becomes possible to easily trace how the communities are being formed, resulting in an easily explainable model that allows the detection of overlapping communities. The disclosed method starts from data representing social interactions between individuals, building a weighted social graph where the vertices represent individuals and the links represent social relationships between individuals.

### OBJECT OF THE INVENTION

As expressed in the title of this specification, the present invention relates to a method for detecting social communities and groups in large social networks by means of an agglomerative approach. Although the present invention can be applied to many domains, the main fields of application are sociology, biology, information technology and telecommunications. The problem of detecting communities is highly complex and has not been satisfactorily solved until now, especially for very large social networks.

### BACKGROUND OF THE INVENTION

The existing algorithms for detecting communities can be divided into two categories: agglomerative or incremental methods and dividing or partitioning methods. Partitioning techniques consider the entire social network and, in an iterative manner, divide it into sub-communities, whereas incremental techniques progressively cluster nodes into larger communities until the stop condition is met. Other authors classify detecting communities into two categories: a) methods which allow detecting overlapped communities, i.e., each node can belong to more than one community, and b) methods requiring that each node belongs at most (or exactly) to one community. Approaches such as that described in the article “Extracting Dense Communities from Telephone Call Graphs” are neither agglomerative nor dividing approaches, but rather they search for communities based on maximizing a measurement, such as density, for example. On the other hand, the article “Comparing Community Structure Identification” provides a good summary and comparative analysis of the existing approaches.

Furthermore, there are some widely studied graph patterns corresponding to cohesive sub-groups of individuals:

Component: a connected component of an undirected graph is a subgraph in which any pair of vertices is connected to one another by any path and to which no more vertices or edges can be added while at the same time preserving the connectivity thereof.

Clique: a subgraph in which each vertex is connected to the other vertices of the subgraph.

Cycle: path having the same starting node as the beginning and the end.

Definitions that are alternatives to concepts described above, such as those shown in the document “Introduction to Social Network Methods” have also been proposed:

N-clique: is a community in which each node should be able to be reached in less than “n” steps (generally, in two steps). This basically entails relaxing the condition of a clique in which each vertex is accessible from the other vertices.

N-clan: is a limited N-clique which does not allow connections through nodes which are not contained in N-clan. It must be taken into account that in an N-clique, the connection can be made through nodes that are outside the N-clique.

K-plex: In a K-Plex, a vertex is a member of a community if it is directly connected to all the other vertices of the community, except to “k” of them.

The following patents related with the present invention have been identified:

In US2009228296 and U.S. Pat. No. 7,499,965, the social relationships and social communication do not define the communities, but rather the common interests of the people are what allow clustering them together.

Patent US2009248434 relates transactions between clients (behavior) with the implicit and explicit social relationships between them (influence). This patent does not use social community information.

Patent US2009233629 links GPS location data and social networks, but by using a list of friends defined explicitly by the user, and understands the list of the friends declared by the user as the social group.

The solutions existing today have at least one of the following problems:

Graph partitions as social communities: many methods reduce detecting communities to a partitioning problem in which all the nodes necessarily belong to a community. Artificially forcing individuals to be members of a community without having sufficient evidence of this relationship is generally not a suitable strategy because the cohesion of the graph decreases, giving rise to scattered communities that do not reflect the actual social structure.

Excessively cohesive communities: some approaches offer an excessively restrictive definition of the community (communities defined as cliques in the extreme case or those which only perform a clique merging iteration, such as the clique percolation algorithm, for example). These approaches only allow the partial identification of a subset of the communities that can be found in the social network.

Non-overlapped communities: other approaches do not allow detecting overlapped communities. However, people usually belong to several communities (groups of friends, family, clubs, etc.)

Unexplainable results: most approaches do not allow tracing the process of detecting communities or intuitively explaining how the groups have been detected. This frequently occurs in the approaches based on maximizing an overall measurement, for example, modularity or density.

Lack of flexibility: existing methods are often too rigid to be combined with other techniques, and there is insufficient control over the parameters which configure the definition of community used.

Excessively specific communities: some techniques are developed exclusively for specific objectives.

Scalability: many approaches are not viable for handling social networks with millions of people and relationships.

Single-block architecture: most approaches are articulated in a single, monolithic block, such as cluster-based algorithms. However, multiblock methods allow different configurations in which the “small parts” of the architecture can be interchanged without modifying the general structure and its functioning.

Efficiency: the computing time is an important obstacle in many cases.

Weighted links: most methods do not take into account the strength of the relationship between individuals in the process of detecting communities. Some methods distinguish between strong and weak social relationships, but they do not use the exact strength of the relationship, or they simple discard weak social links.

To date, no invention has satisfactorily solved all the problems considered above.

From the commercial viewpoint, social networks are a source of information that allows companies to improve their products, services and relationship with their clients. Therefore, the object of the present patent is to describe a new scheme containing knowledge about the user which jointly combines the analysis of the interactions of the users in each social context. It must be taken into account that the user behaves differently depending on each social context.

Understanding interactions between users offers companies new opportunities to improve communication with their users and with the public in general.

The present invention can be used by targeted advertising distributors, i.e., to send customized advertisements to each client. The present invention thus offers the possibility of finding a potential client that may be interested in a product and thus finding a direct communication channel between the sales company and the end client. Communities of users having the same tastes can also be targeted.

This information can further be used for a wide range of applications such as: brand communication, recommendation of products, services or social activities, detection of events, etc.

### DESCRIPTION OF THE INVENTION

To achieve the objectives and avoid the drawbacks indicated above, this patent describes a flexible and efficient method for detecting communities in large-scale social networks which can be classified as an agglomeration method. The social network nodes are not clustered into communities in a single step. Instead, core communities are first built and are gradually clustered together in an iterative manner, forming higher level communities until the algorithm converges (a stop condition is met). Furthermore, this process allows observing how the communities grow effortlessly, giving rise to an easily explainable model.

The described method further allows detecting overlapped communities because an individual can have different social circles. On the other hand, some people may not belong to any community because social networks are often built from partial observations of social interactions. Therefore, there may be people for whom there is insufficient data that allows determining what their social circles are. Forcing a person to belong to a community is generally not a suitable strategy because the cohesion of the graph decreases, which means that the communities are more scattered and, as a result, the detected communities may not reflect actual social groups.

The present method starts from data representing social interactions between the individuals of one or ‘k’ non-overlapped periods of time. The social relationships can be extracted from this social interaction data, for example, telephone calls or emails, by building a weighted social graph where the vertices represent individuals and the links (also called edges) represent social relationships between individuals and the intensity of the relationship. In the method described herein, the weighted combination of the data corresponding to social interactions in different periods of time is allowed such that not only more recent interactions but also the historical data can be taken into account. The result is that the created social network and the detected communities better represent social relationships and are therefore more stable and robust.

The approach of the present invention is different from the already existing approaches because the core communities or cliques (densely connected communities) are first detected and then they are combined to obtained higher level communities in an iterative manner taking into account the strength of the relationships between the individuals (the weights of the links of the social graph). This allows finding communities which are neither too cohesive nor too scattered; my friends' friends are not always my friends as assumed by N-cliques or N-clans. Sometimes, the overall cohesion of a community will allow some vertices to belong to the community despite not being directly connected to all the other members of the community. It is assumed that the community is cohesive enough so that there can be other forms of communication between these vertices. For example, even though a definition of “cliques”-based communities has the desired density values and a longer route between each pair of nodes, they must meet an excessively strict condition because all the nodes must be linked to the other nodes.

The design of the method follows a multiblock configurable strategy where the different stages (building the social graph, detecting cliques, merging communities and including associated members) are designed as functional blocks, with well-defined input and output. This means that the blocks can be replaced at any time for the purpose of satisfying the particular needs of the scope of application, and that the parameters for the functioning of each block are known and can be adjusted to offer a flexible solution.

In this invention, some blocks can be replaced with others which have a similar functioning.

Therefore, as discussed above, the present invention relates to a method for detecting communities in massive social networks by means of an agglomerative approach. The social communities and groups are formed by individuals, users or members who interact with one another and these nodes are represented in a social graph by means of the nodes or vertices of said graph, whereas the links represent the social interaction between the connecting users or members. Social interactions between individuals include telephone calls, emails, SMS, MMS, virtual social interactions other than the aforementioned and they are susceptible to being analyzed, as well as a combination thereof.

A user will previously establish configuration parameters in a range such that: d≧1, NM≧2, j>0, 0≦const≦1, 0≦vt≦1, α>0 and τ>0. Furthermore, a clique is defined as a fully connected subgraph. Therefore, the main phases of the mentioned method are:
1) building a social graph from the information obtained about each social interaction between pairs of individuals belonging to one and the same social network by assigning a weight to each link between pairs of individuals. Said weight represents the social intensity and is calculated based on the amount of social interactions between both individuals;
2) analyzing and detecting the cliques existing in said social graph, said cliques being fully connected communities formed by at least 3 individuals and the links between said individuals being those which have a link strength value above the parameter “α”; and,
3) merging the clicks first and then merging the communities in an iterative manner until meeting a stop condition, said communities and cliques being those which have a cohesion function value above the parameter ‘j’ and said communities and cliques having previously been selected for being merged by means of the analysis and detection of phase 2) of said communities in each iteration.

In turn, for the phase of building the social graph, the input is a set “l” of data relating to social interactions between users. Each interaction is defined as “γ” belonging to “l” and said “γ” is described as a tuple (vᵢ,vⱼ,t,p₁, . . . , pₙ) where “vᵢ” and “vⱼ” are any two individuals interacting with one another, “t” is the moment in which said social interaction occurs and “p₁, . . . , pₙ” are the properties of the social interaction, which in a preferred embodiment will be the type of interaction, the type of communication channel and the location information.

The phase of building the social graph comprises the following steps:
comparing the values “t” of each social interaction and identifying a “tₘᵢₙ” as the moment in which the first social interaction occurs and a “tₘₐₓ” as the moment in which the last social interaction occurs;
dividing the time interval [tₘᵢₙ, tₘₐₓ] into a finite number “d” of time intervals of the same amplitude;
assigning a link strength value, comprised between “0” and “NM”, to the links between individuals by means of a function S(vi,vj), which combines the values of a function “Sₜ” for each time interval “d”, defined by:

S(vᵢ,vⱼ)=Sₜ(vᵢ,vⱼ,0)·w₀+ . . . +Sₜ(vᵢ,vⱼ,d)·w_{d}

and where

$${\sum }_{r = 0}^{d} {w}_{r} = 1$$

Sₜ:VₓVₓ[0,d]→[0,NM] being the function defining the weight of a link between two individuals in each of the “d” time intervals into which [tₘᵢₙ, tₘₐₓ] is divided and “Wᵣ” being defined by the user;
creating a set of strong links, referred to as “Eₛ”, with the links the intensity of which is above “α”,
creating a set of weak links, referred to as “E_{w}”, with the links the intensity of which is below “α”; and,
generating a social graph, with the obtained link strength values, G=(V,E) where “V” is a set of individuals of the graph and “E” contained in “V²” is a set of links of the social graph resulting from the union of sets “Eₛ” and “E_{w}”.

The phase of selecting cliques, the graph G=(V,E) given as an input parameter, comprises the following steps:
creating an empty set, referred to as “L”;
detecting the maximum cliques contained in “G”, said maximum cliques being those cliques the links of which are contained in “Eₛ”, by means of a click detection algorithm and where the vertices of said cliques are individuals belonging to the social network;
storing said cliques in “L”.

Preferably, once the social graph has been obtained the phase of merging cliques which is performed in an iterative manner continues. The empty set “Ωᵢ₊₁” with i:0 . . . M where “M” is the number of iterations performed, has previously been created. Furthermore, the set of maximum cliques “L” detected in the phase of detecting cliques is used as input parameters and Ω₀₌L is defined in the first iteration of this phase of merging cliques. This sub-process is carried out until a stop condition which will preferably consist of a fixed number of iterations defined by the user “M” is met or that the condition “Ω₁₊₁=Ωᵢ” is met. Therefore, the phase of merging cliques comprises the following stages:
selecting, for each community “Cⱼ” belonging to “Ωⱼ”, a set “Uᵢⱼ” contained in “Ωᵢ” of all the communities including an individual of “Cₖ”;
calculating a cohesion value of the result of merging “Cⱼ” with each community of “Uᵢⱼ” by means of a function defined as:

$$cohesion ( {C}_{kuj} ) = \frac{e - m * vt}{h}$$

where “C_{k∪j}” is the community resulting from joining the community “Cⱼ” with “Cₖ”, “Cₖ” being a community belonging to “Uᵢⱼ”, “z” is the number of individuals of “C_{k∪j}”, “e” is the sum of the link strength values for the links between the individuals of “C_{k∪j}”, “m” is the number of links with a link strength value equal to 0 and “h” is the number of links between both communities calculated by means of the function:

$$h = \frac{z \cdot ( z - 1 )}{2}$$

and selecting those communities yielding a cohesion value above the parameter “j” previously defined by the user; and,
creating a set “Vᵢⱼ” and storing in “Vᵢⱼ” the communities selected in the preceding stage and performing the following sub-stages for each community of “Vᵢⱼ” and increasing the counter “i” with each iteration:
   building a graph Gᵢⱼ=(Vᵢⱼ,Eᵢⱼ) where the vertices are the communities of “Vᵢⱼ” and “Eᵢⱼ” the set of links between said communities;
   detecting the cliques contained in “Gᵢⱼ”, said maximum cliques being those cliques the links of which are contained in “Eₛ” and which are not contained in other larger cliques, by means of a click detection algorithm, where the vertices of said cliques are the communities of “Vᵢⱼ”;
   storing the resulting communities in a set, “Lᵢⱼ”; and,
   adding said communities contained in “Lᵢⱼ” to set “Ωᵢ₊₁”.

In another preferred embodiment, in the phase of including associated members, “Ωᵢ” which is the set of communities resulting from the merger performed in the preceding phase and the graph G=(V,E) is used as an input parameter. Said phase of including associated members comprises the following stages:
creating for each community “Cⱼ” belonging to “Ωᵢ” a set “Wⱼ” where the members associated with each community are stored, said associated members being those members having weak links with said community and initializing each of these sets as empty sets; and,
selecting for each individual, “v” belonging to “V”, who belongs to less than “N” communities, “N” being a parameter defined by the user, a set “Ψ” contained in “Ωⱼ” of communities including an individual having a link with “v” and not including “v” and performing the following sub-stages in an iterative manner with each of the communities “Cⱼ”:
   creating a set of individuals Dif(Cⱼ,Ψ)=Cⱼ−Ψ made up of the individuals of “Cⱼ” who do not belong to “Ψ”;
   creating a set of individuals Inters(Cⱼ,Ψ)=Cⱼ∩Ψ made up of the individuals of “Cⱼ”, such that they are in “Ψ”;
   calculating an intensity value of each individual “v” with each community “Cⱼ” by means of the function defined as:

$$intensity ( v , {C}_{j} ) = \frac{k - const * \vert Dif ( {C}_{j} , Ψ ) \vert}{\vert {C}_{j} \vert}$$

where the parameter “const” establishes the penalization threshold for “non-links” and is previously defined by the user, the value “k” is the sum of the link strength values of the individuals of Inters(Cⱼ,Ψ) with “v”, and where the operator “|Cⱼ|” denotes the number of individuals of the set “Cⱼ”; and,
including the individuals “v” for whom the value of the intensity function is equal to or greater than a parameter “τ” defined by the user in the set “Wⱼ” associated with the community “Cⱼ” corresponding to said user.

In another preferred embodiment, an additional phase of including dyads is carried out, said dyads being communities of two members, comprising the following stages:
detecting communities of two individuals contained in the graph “G” not belonging to communities of more than two individuals; and,
storing said communities in the list of communities found in the set “Ωᵢ₊₁”.

In another preferred embodiment and although different clique detection algorithms can be used as previously stated, this algorithm has been used specifically by way of example. Said click detection algorithm uses the graph D=(A,B) as an input parameter, the set A of vertices of the graph being selected from a set of individuals and a set of communities and the set B of links of the graph being selected from a set of links between individuals and a set of links between communities. Said algorithm comprises the following steps:
selecting a subgraph “Dᵢ” contained in “D”, “Dᵢ” being the graph of a vertex “i”, and a triangular matrix “Mᵢ” associated with “Dᵢ”, said matrix “Mᵢ” being the matrix of communications between the vertex “i” and the vertices with which it has links; and,
executing the following sub-phases for each vertex of “Mᵢ” with those with which the vertex “i” has links:
   selecting a clique “Q” contained in “Dᵢ” and a set of vertices, “P” contained in “A”, the vertices of which are neighbors of the vertices of “Q”;
   verifying that the union of “Q” with each of the vertices of “P” is also a clique;
   adding the vertices that verify the preceding phase to “Q”; and,
   including “Q” in “L” when there are no longer vertices to be added to “Q”.

The main problems with the existing solutions that have been overcome in the present invention are the following:
The communities are configurable: the described approach allows multiple strategies, depending on the scope of application. People are therefore not forced to belong to any community because it is possible to find isolated users, in most cases as a result of the few available observations of social interactions.
The communities are overlapping: this approach allows communities to overlap. This means that an individual can belong to more than one community.
Traceability: this process allows tracking how communities are gradually generated.
Comprehensible: it is a very clear method with respect to understanding how communities are obtained.
Flexible: easy to combine with other techniques.
Generic: it is neither ad-hoc nor does it depend on specific objectives.
Scalable: it is capable of handling increasing greater amounts of nodes in an agile manner.
Multi-block architecture: the blocks of the architecture can be replaced with other modules performing a similar function.
Efficiency: reduced computing times allow working almost in time real.
Weighted links: this method takes into account the strength of the communication between the individuals.

### BRIEF DESCRIPTION OF THE DRAWINGS

FIG. 1 shows the flowchart of the general method of the invention.

FIG. 2 shows the diagram of an example of a clique formed by 4 individuals and their social relationships.

FIG. 3 shows the flowchart of a method for detecting cliques.

FIG. 4 shows the flowchart of a method for merging social communities and groups.

FIG. 5 shows an embodiment of the merger of a community.

FIG. 6 shows a method for including associated members.

FIG. 7 shows an embodiment of an inclusion of an associated member.

### DESCRIPTION OF AN EMBODIMENT

A description of an embodiment of the invention is provided below with an illustrative and non-limiting character making reference to the reference numbers used in the drawings.

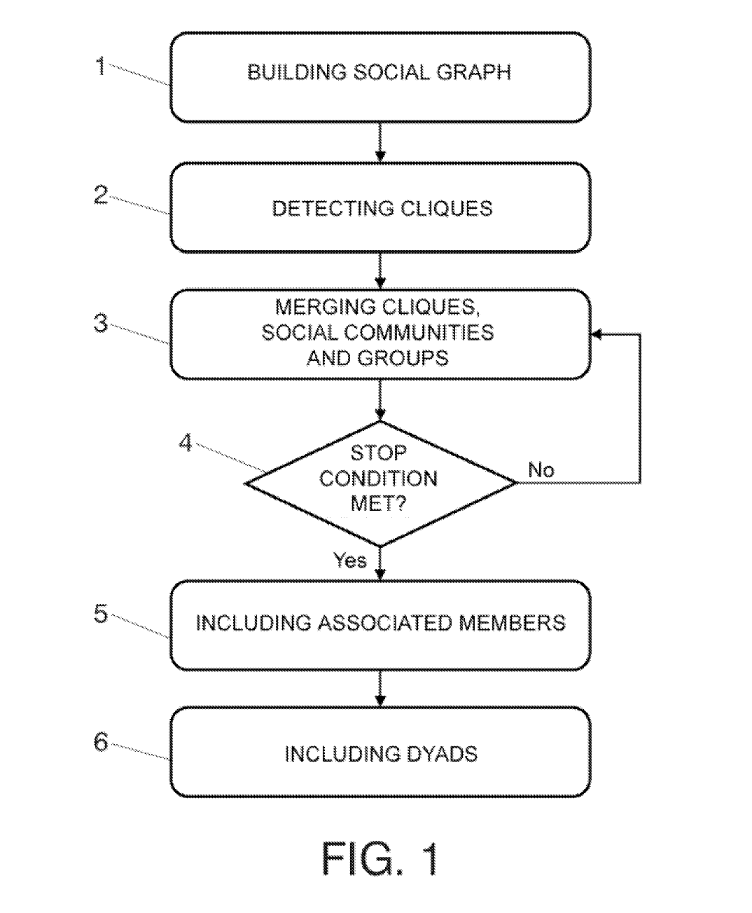

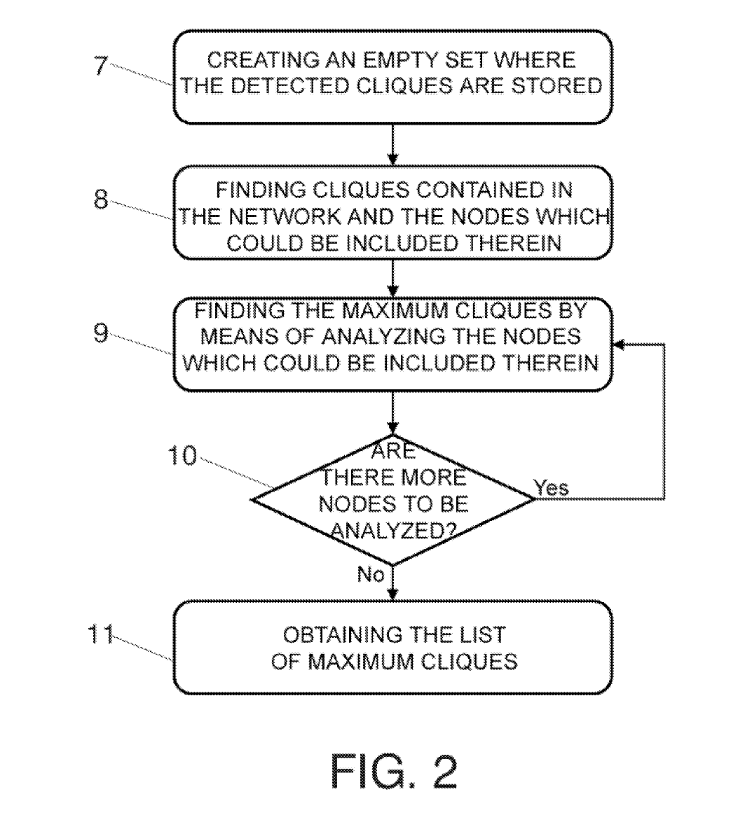

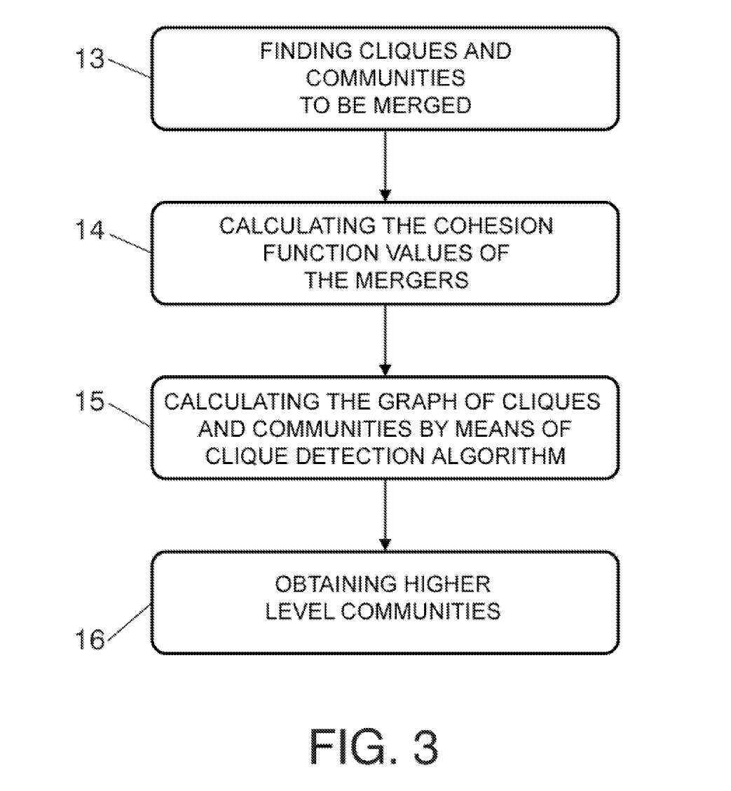

The first block (1) of FIG. 1 builds the social graph representing the individuals and their social relationships, extracted from different data sources.

The inputs for this block are the data describing a set “I” of social interactions, captured from any source providing information about social interactions between individuals: what the individuals interact about, when this interaction occurs, and the attributes of the interaction such as the type (for example, by telephone, SMS, email, meetings) or the location. Each interaction “γ∈l′” can be described by a tuple (vᵢ,vⱼ,t,p₁, . . . , pₙ), where “vᵢ” and “vⱼ” are two interacting individuals, “t” is the moment in which this interaction occurred, and “p₁, . . . , pₙ” are the properties of the interaction, such as the communication channel or the location of the information.

The output of this functional block is a weighted and undirected graph “G=(V,E)” representing the social network extracted from the data about the interaction received as input. In this graph, “V” is the set of vertices or nodes, which correspond to the users or individuals, and “E contained in “V²” represents the set of the links of the graph, representing the social relationships between individuals. A weight or strength of the relationship is defined for each link (vᵢ,vⱼ).

Taking into account the set of interactions that are received as input, the moment in which the first interaction occurs will be denoted as “tₘᵢₙ”, i.e., “∀γ=(vᵢ,vⱼ,t,pᵢ, . . . , pₙ)∈I,t≧tₘᵢₙ”, and the moment in which the last interaction occurs will be denoted as “tₘₐₓ”, i.e., ∀γ=(vᵢ,vⱼ,t,pᵢ, . . . ,pₙ)∈I,t≦tₘₐₓ. The time interval “[tₘᵢₙ, tₘₐₓ]”, corresponding to the observation period, is divided into a finite number “d” of intervals or periods of equal duration, with d≧1.

However, the observation period may not be continuous, for example, interactions have been observed in two non-consecutive months, or the observation period is to be divided into intervals of a different duration. For these reasons the invention allows dividing the set of interaction data into time intervals.

Taking into account the set of interactions “I” and the partition of the observation period into intervals “d”, the links which represent the social relationships are obtained by means of applying a function on the number of social interactions between each pair of vertices (people) for each time period, and the properties of such interactions. This function can apply different weights to the interactions in different time intervals. The historical data can therefore be weighted such that older interactions are less relevant than recent interactions.

The subset of interactions between two individuals “(vᵢ,vⱼ)” during the time interval “r” is denoted “I(vᵢ,vᵢ,r) contained in I”. A random function is defined in this sub-group of interactions which assigns a strength value for the social relationship between the individuals and, in this time period, based on the interactions that have occurred. This function “Sₜ:VₓVₓ[0,d]→[0,NM]” can define the strength of the relationship, for example as the total number of social interactions of any type between “(vᵢ,vᵢ)” in the considered interval, as the number of emails exchanged, or using any other random function on the set of interactions between the individuals considered, possibly taking into account the properties of these interactions.

The function of the general strength, which combines the values of “Sₜ” for all the time intervals defined is defined on the basis of this function:

$$S ( {v}_{i} \cdot {v}_{j} ) = {S}_{t} ( {v}_{i} , {v}_{j} , 0 ) \cdot {w}_{0} + … + {S}_{t} ( {v}_{i} , {v}_{j} , d ) \cdot {w}_{d}$$

$${\sum }_{r = 0}^{d} {w}_{r} = 1$$

The value of a link therefore ranges from 0 to “NM”, 0 being the absence of social relationship between two individuals in the definition of a social relationship given by the functions “Sₜ” and “S”.

Two types of relationships are distinguished depending on the strength of the social relationship. The relationships “(vᵢ,vⱼ)” are referred to as “strong relationships”, such that “S(vᵢ,vⱼ)≧α”, where “α” is a configurable threshold, and those relationships the strength of which defined by the function “S” is below this threshold “α” are referred to as “weak relationships”. Intuitively, weak relationships represent occasional interactions between each pair of individuals and strong relationships correspond to frequent and permanent interactions. The subset of “E” the relationships of which are strong is denoted as “Eₛ”, and the subset of “E” the relationships of which are weak is denoted as “E_{w}”, such that “E=Eₛ∪E_{w}”.

In the second block (2) of FIG. 1, the “seed” communities having at least 3 members are built, i.e., groups of people for whom the greatest possible evidence of their social connection is available based on the built social network. These communities, given by what is defined as “strong cliques”, form the core of the communities that are in subsequent stages.

The input for this clique detection block (2) is the weighted social graph “G=(V,E)” representing the social relationships between individuals.

The output of this block is the set “L” of “maximum cliques”, they will also possibly be overlapping strong cliques that are in the social graph “G”.

In graph theory, a clique is a subgraph (or a subset of vertices) “Q contained in G”, in which each vertex “vᵢ∈Q” is connected to all the other vertices “′vⱼ∈Q” i.e., “∀vᵢ,vⱼ∈Q(vᵢ,vⱼ)∈E”. The size of a clique “Q”, which is denoted “|Q|”, is the number of vertices it contains and in a preferred embodiment, there are at least 3 members.

The reason for searching for cliques in this step is that cliques are the most strongly connected groups of vertices that can be found in a graph, i.e., they are the groups of people for which the strongest possible social connection can be observed. However, in the weighted graph calculated herein, the weight of a link represents the strength of the social relationship. Therefore, a more detailed definition of clique taking this strength into account can be conceived.

A “strong clique”, “Qₛ contained in G”, is particularly defined as a subgraph in which each vertex “vᵢ∈Qₛ” is connected to each other vertex “vᵢ∈Qₛ”, with a strong relationship such as that described above, i.e., “∀vᵢ,vⱼ∈Qₛ(vᵢ,vⱼ)∈E” where “G=(V,E)” and “E=Eₛ∪E_{w}”.

The objective is to find maximum strong cliques, i.e., the strong cliques the vertices of which are not contained in a single larger clique, allowing them to overlap, i.e., the same vertex can belong to more than one strong clique.

Given a strong clique “Qₛ” and a vertex “vᵢ” outside “Qₛ”, “vᵢ” is established as being susceptible of, being added if the subgraph resulting from adding “vᵢ” to “Qₛ(Qₛ∪{vᵢ})” is also a strong clique of “G”. It is deduced from this definition that a maximum clique is a clique with the greatest possible number of vertices because it does not have other vertices susceptible of being added.

The objective of the extraction of these highly connected communities is to find the cores of high level communities. These cliques are merged in subsequent steps, giving rise to large communities. Furthermore, it is important to point out that “weak relationships” are not used in this phase because the main objective is to obtain all the strong social circles of each client, finding all the maximum cliques of any size.

In principle, any algorithm can be used for detecting overlapping cliques, obtaining a set “L” of all the strong maximum cliques that are found in the graph.

In a preferred embodiment of the invention, the present algorithm for detecting maximum and possibly overlapping cliques has been chosen:
1. Considering an empty set “L≠φ”, which will contain the maximum cliques said maximum cliques being those the links of which are contained in “Eₛ” (7).
2. Considering a subgraph, “Gᵢ⊂G”, which corresponds to the social graph of the user “i” and the triangular matrix, “Mᵢ” associated with “Gₜ”
3. For each node, iteratively, observing the neighboring node in “Mᵢ” as long as there are other non-explored nodes.
   3.1. Considering a possible clique (8) “Q⊂Gᵢ” and a set of nodes, denoted as “P⊂V”, the nodes of which could also belong to “Q” because they are also neighbors of each node “vⱼ” contained in “Q”:

∀vᵢ∈P/vᵢ∉QΛvᵢ˜Q→Q=Q∪{vᵢ}
3.2. If “Q” does not have vertices that can be joined, “P=φ”, then “Q” is a clique→“L=L∪Q” (9).
3.3. On the other hand, for each vertex susceptible of being joined, “vᵢ⊂P/vᵢ˜Q′”→is added recursively to “Q”, “Q=Q∪{vᵢ}”.
   3.4. Eliminating “vᵢ” and any other vertex “vⱼ” that is not a neighbor of “vᵢ” from “P”.
4. Repeating it until there are no more nodes in “P” (10).
5. If the stop condition is not met, go to a 3.) and increase a counter.

A pruning function that avoids all the paths that have already been explored, ignoring the links starting from already analyzed nodes, is applied. Therefore, there are no links that are explored twice. The algorithm iteratively explores the graph searching for new cliques and updating relationships between contacts. The process ends when all the links have been analyzed and the list of maximum cliques found is obtained in “L” (11). The algorithm does not extract combinations of nodes for one vertex “vᵢ” with another vertex “vⱼ” with a lower security value because these nodes have previously been generated by “vⱼ”.

In the third block (3) of FIG. 1, once the most cohesive communities (the cores of the communities) have been found, one or more steps of merging cliques and communities is carried out for creating higher level, larger communities.

The block operates in an iterative manner. In the first iteration, the community cores (cliques) are analyzed, resulting in communities formed by merging 2 or more cliques as well as the communities which could not be merged. The communities which are obtained are the input for subsequent iterations. The previously found communities will attempt to be merged in each iteration. This process will continue until a stop condition (4) is met.

The input for merging communities is the set “Ωᵢ” containing the communities found in the second block (2). In the first iteration of the process of merging the community “Ωᵢ=L”, i.e., the input is the set of strong maximum cliques found in “G” in the second block (2).

The output is a set of higher level communities “Ωᵢ₊₁” as a result of merging the communities of “Ωᵢ”.

In this step, the objective is to find the communities in the set “Ωᵢ” which can be combined in a single community. To decide which communities are susceptible of such merger, a measurable and configurable criterion that gives the user control over the restrictions that are laid down for forming higher level communities has been defined. This criterion is based on the definition of a cohesion function.

Two communities of “Ωᵢ” are denoted as “Cₐ” and “C_{b}”. The community resulting from the union of all the vertices of “Cₐ” and “C_{b}” is denoted as C_{a∪b}=Cₐ∪C_{b}.

The variable “v” is used to indicate the number of vertices appearing in the new community as a result of the merger of “Cₐ” and “C_{b}” and the variable “e” is used to denote the sum of the strengths of the links between the vertices of “C_{a∪b}”, taking into account the strong and weak relationships, i.e., “′e=Σᵥ_{ᵢ}_{,v}_{ⱼ}_{∈c}_{_{a∪b}}S(vᵢ,vⱼ)”.

The number of possible links between the vertices of a community “C_{a∪b}”, defined by

$$“ h = \frac{e - m * vt}{h} ” ,$$

is denoted as “h”.

Wherein “m” is the number of links with a strength equal to zero and “vt” is a configurable constant which is used to penalize said links.

Cohesion is calculated using the following function:

$$cohesion ( {C}_{kuj} ) = \frac{e - m * v t}{h}$$

It can be observed that the community cohesion value ranges from “−m*vt” to 1. However, since the communities are densely connected, the lowest value will not be reached, whereas the upper value can only be obtained by a clique. Given that all the maximum cliques were detected in the preceding block (2), the cohesion between any pair of the communities will never reach the value of 1.

Once the community cohesion calculation function has been entered, the functioning of the merger of communities can be described in detail as follows:
1. Initializing the output set “Ωᵢ₊₁=φ”. This set will store the communities as a result of the iteration of the merger of the community.
2. For each community “Cⱼ∈Ωᵢ”:
   2.1. Selecting the set “Uᵢⱼ” contained in Ωᵢ” of all the communities including a vertex of “Cⱼ” (13),

∃vₖ,vₖ∈CᵢΛvₖ∈Cⱼ [symbol] Cᵢ∈Uᵢⱼ
2.2. Calculating the cohesion of the result of merging “Cⱼ” with each community of “Uᵢⱼ”, and selecting the communities of “Uᵢⱼ” in which the community resulting from the merger with “Cⱼ” has cohesion function values above a threshold “h” defined by the user. These communities will make up the set “Vᵢⱼ” (14),

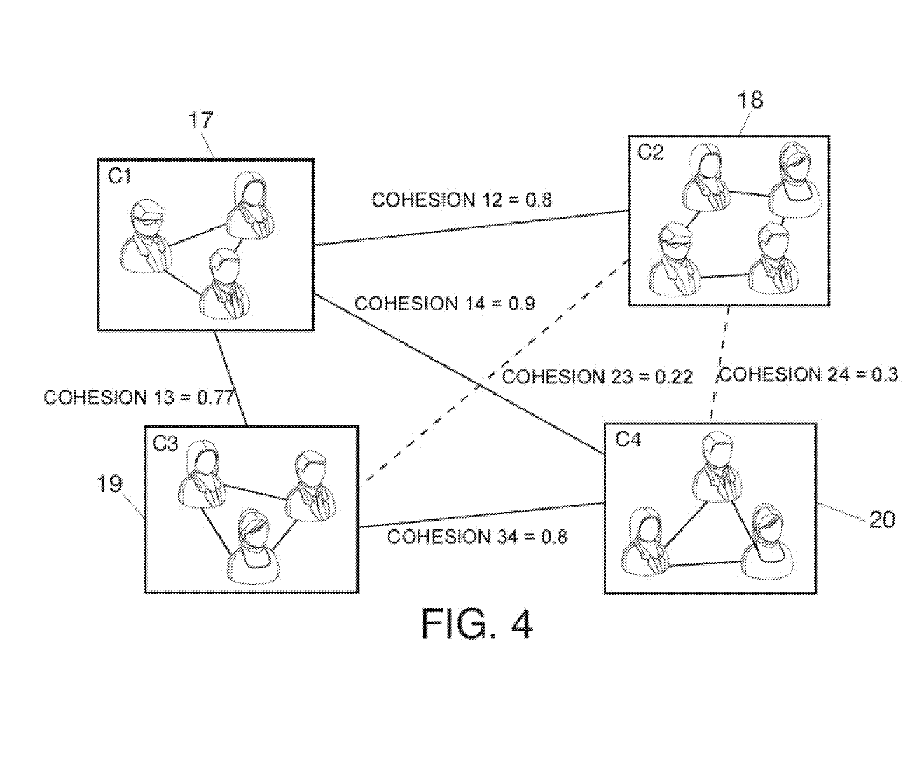

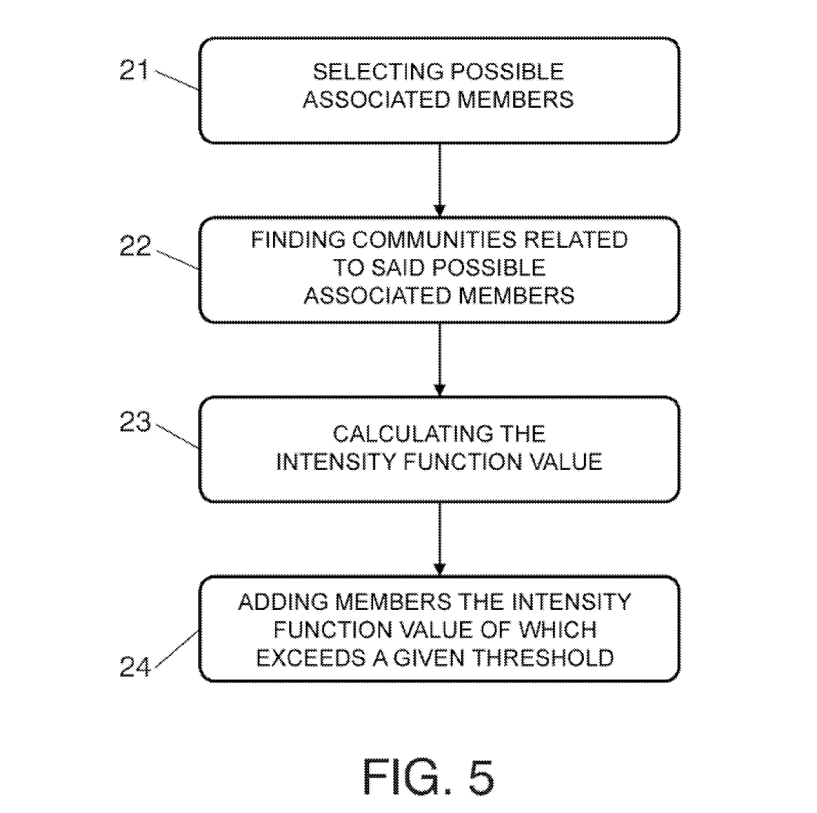

cohesion(C_{k∪j})≧h [symbol] Cₖ∈Vᵢⱼ
2.3. Building (15) a graph “Gᵢⱼ=(Vᵢⱼ,Eᵢⱼ)”, where the vertices are the communities of “Vᵢⱼ”, and there is a link between two communities, if the cohesion of the combination of these communities is above the threshold “h”, i.e., (Cₖ,Cᵢ)∈Eᵢⱼ [symbol] cohesion(C_{k∪l})≧h. An example of this graph is shown in FIG. 4.
2.4. Finding (16) the set “Lᵢⱼ” of maximum and possibly overlapping cliques in the graph “Gᵢⱼ”. Each clique of “Lᵢⱼ” is defined by two or more communities in “Qᵢ”, and defines a new community resulting from the merger of said communities.
2.5. Adding the elements of “Lᵢⱼ” to the output set “Ωᵢ₊₁: Qᵢ₊₁=Qᵢ₊₁∪Lᵢⱼ”. If “Lᵢⱼ” is empty, Ωᵢ₊₁=Ωᵢ₊₁∪Cⱼ. Given that the same “clique” of communities can be detected on several occasions, only one copy of each new community is maintained in the set “Ωᵢ₊₁”. Higher level communities are obtained as a result.

The merger of the communities is performed in an iterative manner until convergence is achieved, i.e., until “Ωᵢ₊₁=Ωᵢ”. Depending on the domain of application, the stop conditions can be defined in different ways, such as establishing a specific number of iterations for example.

FIG. 4 shows an example of the method of merging described above with four communities, where C1 (17) is the community being studied. C2 (18), C3 (19) and C4 (20) are the communities that have reached the established threshold, “h”, with C1. The strength of the relationships with respect to one another is then defined by means of applying the cohesion function. The threshold “h” is considered and the other links that do not reach the threshold are “eliminated”. There are links between members C2 and C3. However, since the cohesion function of the merger of C2 and C3 does not yield a value greater than or equal to the threshold “h”, these communities are not considered as candidates for the merger. The same reasoning is followed for C2 and C4. Once the relationship between them has been determined, the clique algorithm is applied, and two higher level communities are obtained: (C1, C2) and (C1, C3, C4).

The inclusion of individuals (associated members) who are not previously included in at least “N” communities because they do not have strong enough communication with the other individuals of the communities is carried out in the fifth block (5) of FIG. 1. However, these individuals can have many weak communications which must be considered. To associate them with the corresponding communities, the communities that are closely related with them through either strong or weak relationships must be analyzed.

The input parameters for this block are the set “Ωⱼ” which contains the communities found and the weighted social graph “G=(V,E)” described above.

With respect to the output of the block, a set of associated members “Wᵢⱼ” is obtained for each community “Cᵢⱼ” in “Ωᵢ”, which contains the members that can be associated with “Cᵢⱼ” which further complies with a limitation depending on an intensity constant.

First the vertices must be evaluated in order to decide whether or not they can be included as associated members of an existing community. The decision will be made according to a criterion based on the definition of an intensity function, which is described in detail below.

Taking a node “vₖ∈V” of the graph “G”, and “Cᵢⱼ∈Qᵢ” being one of the higher level communities found in section 3.3.

“Nₖ=N(vₖ)” is defined as the set of neighboring nodes of “vₖ”, i.e., the group of vertices “vₖ∈V”, connected with “vₖ∀m/(vk,vm)∈E”.

The difference will be formed by the vertices of “Cᵢⱼ” which are not in “Nₖ”:“Dif(Cᵢⱼ, Nₖ)=Cᵢⱼ−Nₖ” and in the same manner, a set with the common vertices belonging to “Cᵢⱼ” and to “Nₖ” is defined: “Inters(Cᵢⱼ, Nₖ)=Cᵢⱼ∩Nₖ”.

A variable “ek” is further defined to denote the sum of the strength of the vertices of “Inters(Cᵢⱼ, Nₖ)” with the vertex “vₖ”:

$${e}_{k} = {\sum }_{{v}_{i} ( Inters ( Cij , Nk )} S ( {v}_{i} , {v}_{j} )$$

The operator “|C|” will indicate the number of elements of the community or set “C”.

Then the intensity of the relationship which the node “vₖ” maintains with the community “Cᵢⱼ” is evaluated using the following function:

$$intensity ( v , {C}_{j} ) = \frac{k - const * \vert Dif ( {C}_{j} , Ψ ) \vert}{\vert {C}_{j} \vert}$$

The variable “const” will then be varied depending on how much the lack of communication is to be penalized. The higher its value, the more restrictive the inclusion of associated members in the communities is.

It is easily deduced that the intensity values range from “−const”, which means nil relationship of the vertex “vₖ” with the community “Cᵢⱼ”, to “1”, which is the maximum relationship of the vertex with the community.

The method for including the associated members is the following:
1. For each community “Cⱼ∈Ωᵢ” a set of associated members “Wⱼ” (21) of the community “Cⱼ” is created and is initialized as an empty set “Wⱼ=φ”.
2. For each vertex “v∈V” which belongs to no more than “N” communities:
   2.1. Selecting (22) the set “Ψ” contained in “Ωᵢ” of all the communities including a vertex of “N(v)”, neighboring nodes of “v”, and not including the vertex “v”.
   2.2. Calculating (23) the intensity which the vertex “v” maintains with each community in “Ψ”, and selecting the communities the intensity values of which are above a value threshold “τ” such that:

intensity(v,Cⱼ)≧τ
2.3. Adding (24) the vertex “v” to the “Wⱼ” the “j” of which complies with the in equation of section 2.2.

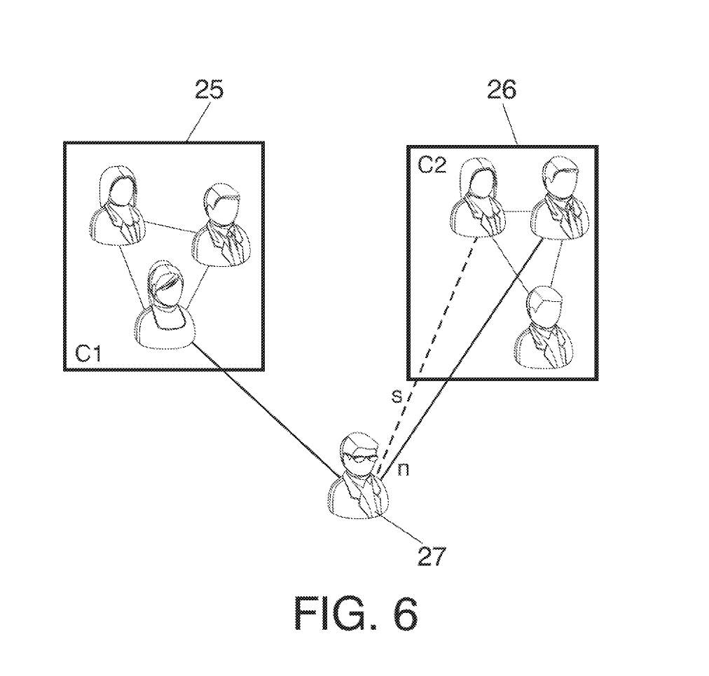

FIG. 6 shows an example of how this method for including dyads works. “0” is established as the value for “const” and “0.6” as the threshold “t”. “n” (27) is the node that is observed, so “Nₙ” will be the set of neighboring nodes, and “C₁” (25) and “C₂” (26) are the communities belonging to “Ψ” (2.1). The intensities are evaluated and it is seen how “Inters(Nₙ,C₁)” is formed by a single vertex and “Dif(C₁,Nₙ)” consists of two nodes, such that:

$$intensity ( n , {C}_{1} ) = \frac{1 - const * 2}{3} = 0.333 < t$$

The possible inclusion of the vertex “n” (27) in the community “C₂” will also be evaluated, “Inters(Nₙ,C₂)” is formed by two vertices, whereas “Dif(C₂,Nₙ)” contains a single node. If it is assumed that the link strength value “s” is 0.9:

$$intensity ( n , {C}_{2} ) = \frac{( 1 + 0.9 ) - const * 1}{3} = 0.6333 > t$$

Therefore, it is concluded that the vertex “n” (27) will be included as an associated member in the community “C₂” (26), but not in the community “C₁” (25).

The inclusion of dyads is carried out in the sixth block (6) of FIG. 1. In sociology, a dyad is described as a group of two connected people. A dyad is the smallest possible social group. This type of communication is very common in many social networks, sometimes creating islands and hubs or connectors of larger communities in other cases.

Including the dyads in the second block (2) of FIG. 1 as size 2 cliques results in a truly enormous amount of communities that will be the input of the third block (3), enormously increasing the computational load of this block.

Therefore, if communities with two members are to be considered, post-processing is necessary and will be carried out to analyze each dyad and determine if there is a larger community, and if it is not contained, the dyad is stored as a size 2 community.

The approach of the present invention is different from that of other inventions of the state of the art because first cliques (densely connected communities) are detected and combined to obtain higher level communities, taking into account to that end the weight of the links and thus achieving cohesive communities. This allows the vertices to be connected to “friends of friends” only when the number of vertices not directly connected is irrelevant. Unlike n-clique and n-clan techniques, the invention assumes that “my friends' friends are not always my friends”. It is crucial to take into account the volume of communication between the vertices because sometimes the complete cohesion of the community will allow some vertices to belong to said community even when some nodes of the mentioned community are not connected to this new node. The invention assumes that the community is compact enough to assume that there can be other sources of communication between these vertices.

Despite the fact that the cliques have the desired density values and the longest path between each pair of nodes, they must comply with a very strict restriction because all the nodes must be linked with the other nodes of said clique.

1. Method for detecting communities in massive social networks by means of an agglomerative approach, where said communities are formed by individuals, where a user previously establishes configuration parameters, said parameters being defined in a range: d≧1, NM≧2, j≧0, 0≦const≦1, 0≦vt≦1, α≧0 τ>0, where a clique is defined as a fully connected subgraph, in which each vertex, which represents an individual, is connected by means of links, which represent a social interaction between the connecting individuals, to the other individuals forming the subgraph, comprising the following phases:
1) building a social graph from the information obtained about each social interaction between pairs of individuals belonging to one and the same social network by assigning a weight to each link between pairs of individuals, said weight representing a strength of the link defined as the intensity of the social interaction between each pair of individuals of the social graph calculated based on the amount of social interactions between each said pair of individuals;
2) analyzing and detecting cliques existing in said social graph, said cliques being fully connected communities formed by at least 3 individuals and the links between said individuals being those which have a link strength value above the parameter “a”; and,
3) merging the clicks first and then merging the communities in an iterative manner until meeting a stop condition, said communities and cliques being those which have a cohesion function value above the parameter “j” and said communities and cliques having previously been selected for being merged by means of the analysis and detection of phase 2) of said communities in each iteration.

2. Method for detecting communities in massive social networks by means of an agglomerative approach according to claim 1, wherein the phase of building a social graph, where the input is a set “I” of data relating to social interactions between users and where each interaction is defined as “γ” belonging to “I” and where said “γ” is described as a tuple (vᵢ,vⱼ,t,p₁, . . . ,pₙ) where “vᵢ” and “vⱼ” are any two individuals interacting with one another, “t” is the moment in which said social interaction occurs and “p₁, . . . , pₙ,” are the properties of the social interaction, comprising the following steps:
comparing the values “t” of each social interaction and identifying a “tₘᵢₙ” as the moment in which the first social interaction occurs and a “tₘₐₓ” as the moment in which the last social interaction occurs;
dividing the time interval [tₘᵢₙ, tₘₐₓ] into a finite number “d” of time intervals of the same amplitude;
assigning a link strength value, comprised between “0” and “NM”, to the links between individuals by means of a function S(vᵢ,vⱼ), which combines the values of a function “Sₜ” for each time interval “d”, defined by:
S(vᵢ,vⱼ)=Sₜ(vᵢ,vⱼ,0)·w₀+ . . . +Sₜ(vᵢ,vⱼ,d)·w_{d}
and where
$${\sum }_{r = 0}^{d} {w}_{r} = 1$$
Sₜ:VₓVₓ[0,d]→[0,NM] being the function defining the weight of a link between two individuals in each of the “d” time intervals into which [tₘᵢₙ, tₘₐₓ] is divided and “Wᵣ” being defined by the user;
creating a set of strong links, referred to as “Eₛ”, with the links the link strength value of which is above “α”,
creating a set of weak links, referred to as “E_{w}”, with the links the link strength value of which is below “α”; and,
generating a social graph, with the obtained link strength values, G=(V,E) where “V” is a set of individuals of the graph and “E” contained in “V²” is a set of links of the social graph which are established between individuals as a result of the union of sets “Eₛ” and “E_{w}”.

3. Method for detecting communities in massive social networks by means of an agglomerative approach according to claim 2, wherein the phase of selecting cliques, given the graph G=(V,E) as input parameter, comprising the following steps:
creating an empty set, referred to as “L”;
detecting the maximum cliques contained in “G”, said maximum cliques being those cliques the links of which are contained in “Eₛ”, by means of a click detection algorithm and where the vertices of said cliques are individuals belonging to the social network;
storing said cliques in “L”.

4. (canceled)

5. Method for detecting communities in massive social networks by means of an agglomerative approach according to claim 11, wherein the phase of including associated members, where “Ωᵢ” which is the set of communities resulting from the merger performed in the preceding phase and the graph G=(V,E) is used as an input parameter, comprising the following stages:
creating for each community “Cⱼ” belonging to “Ωᵢ” a set “Wⱼ” where the members associated with each community are stored, said associated members being those members having weak links with said community and initializing each of these sets as empty sets; and,
selecting for each individual, “v” belonging to “V”, who belongs to less than “N” communities, “N” being a parameter defined by the user, a set “Ω” contained in “Ωᵢ” of communities including an individual having a link with “v” and not including “v” and performing the following sub-stages in an iterative manner with each of the communities “Cⱼ”:
creating a set of individuals Dif(Cⱼ,Ψ)=Cⱼ−Ψ made up of the individuals of “Cⱼ” who do not belong to “Ψ”;
creating a set of individuals Inters(Cⱼ,Ψ)=Cⱼ□Ψ made up of the individuals of “Cⱼ”, such that they are in “Ψ”;
calculating an intensity value of each individual “v” with each community “Cⱼ” by means of the function defined as:
$$intensity ( v , {C}_{j} ) = \frac{k - const * \vert Dif ( {C}_{j} , Ψ ) \vert}{\vert {C}_{j} \vert}$$
where the parameter “const” establishes the penalization for “non-links” and is previously defined by the user, the value “k” is the sum of the link strength values of the individuals of Inters(Cⱼ,Ψ) with “v”, and where the operator “|Cⱼ|” denotes the number of individuals of the set “Cⱼ”; and,
including the individuals “v” for whom the value of the intensity function is equal to or greater than a parameter “τ” defined by the user in the set “Wⱼ” associated with the community “Cⱼ” corresponding to said user.

6. Method for detecting communities in massive social networks by means of an agglomerative approach according to claim 5, wherein a phase of including dyads is carried out, said dyads being communities of two members, comprising the following stages:
detecting communities of two individuals contained in the graph “G” not belonging to communities of more than two individuals; and,
storing said communities in the list of communities found in the set “Ωᵢ₊₁”.

7. (canceled)

8. Method for detecting communities in massive social networks by means of an agglomerative approach according to claim 1, wherein the social interaction between individuals is selected from telephone calls, emails, SMS, MMS, an electronic social interaction other than the aforementioned and a combination thereof.

9. Method for detecting communities in massive social networks by means of an agglomerative approach according to claim 2, wherein the interaction properties are selected from the type of interaction, the type of communication channel and the location information.

10. Method for detecting communities in massive social networks by means of an agglomerative approach according to claim 11, wherein the stop condition is selected from:
carrying out a fixed number of iterations defined by the user, “M”; and,
the condition “Ωᵢ₊₁=Ωᵢ” being met.

11. Method for detecting communities in massive social networks by means of an agglomerative approach according to claim 1, wherein the phase of merging cliques which is performed in an iterative manner, having previously created the empty set “Qᵢ₊₁” with i:0 . . . M and “M” being the number of iterations performed and where the set of maximum cliques “L” detected in phase 2) is used as input parameters defining Ω₀=L in the first iteration of the phase of merging cliques, comprising the following stages:
selecting, for each community “Cⱼ” belonging to “Ωᵢ”, a set “Uᵢⱼ” contained in “Ωᵢ” of all the communities including an individual of “Cⱼ”;
calculating a cohesion value of the result of merging “Cⱼ” with each community of “Uᵢⱼ” by means of a function defined as:
$$cohesion ( {C}_{kuj} ) = \frac{e - m * v t}{h}$$
where “C_{k∪j}” is the community resulting from joining the community “Cⱼ” with “Cₖ”, “Cₖ” being a community belonging to “Uᵢⱼ”,“z” is the number of individuals of “C_{k∪j}”, “e” is the sum of the link strength values for the links between the individuals of “C_{k∪j}”, “m” is the number of links with a link strength value equal to 0 and “h” is the number of links between both communities calculated by means of the function:
$$h = \frac{z \cdot ( z - 1 )}{2}$$
and selecting those communities yielding a cohesion value above the parameter “j” previously defined by the user; and,
creating a set “Vᵢⱼ” and storing in “Vᵢⱼ” the communities selected in the preceding stage and performing the following sub-stages for each community of “Vᵢⱼ” and increasing the counter “i” with each iteration until a stop condition is met:
building a graph Gᵢⱼ=(Vᵢⱼ,Eᵢⱼ) where the vertices are the communities of “Vᵢⱼ” and “Eᵢⱼ” is the set of links between said communities;
detecting the cliques contained in “Gᵢⱼ”, said maximum cliques being those cliques the links of which are contained in “Eₛ” and which are not contained in other larger cliques, by means of a click detection algorithm and where the vertices of said cliques are the communities of “Vᵢⱼ”;
storing the resulting communities in a set, “Lᵢⱼ”; and,
adding said communities contained in “Lᵢⱼ” to set “Qᵢ₊₁”.

12. Method for detecting communities in massive social networks by means of an agglomerative approach according to claim 3, wherein the click detection algorithm, the graph D=(A,B) given as an input parameter, the set A of vertices of the graph being selected from a set of individuals and a set of communities and the set B of links of the graph being selected from a set of links between individuals and a set of links between communities, comprising the following steps:
selecting a subgraph “Dᵢ” contained in “D”, “Dᵢ” being the graph of a vertex “i”, and a triangular matrix “Mᵢ” associated with “Dᵢ”, said matrix “Mᵢ” being the matrix of communications between the vertex “i” and the vertices with which it has links; and,
executing the following sub-phases for each vertex of “Mᵢ” with those with which the vertex “i” has links:
selecting a clique “Q” contained in “Dᵢ” and a set of vertices, “P” contained in “A”, the vertices of which are neighbors of the vertices of “Q”;
verifying that the union of “Q” with each of the vertices of “P” is also a clique;
adding the vertices that verify the preceding phase to “Q”; and,
including “Q” in “L” when there are no longer vertices to be added to “Q”.
